(19) United States
(12) Patent Application Publication
(10) Pub. No.: US 2005/0116880 A1
(43) Pub. Date: Jun. 2, 2005

(54) System and method for processing frames of images at differing rates

(76) Inventor: Michael Flanigan, Toronto (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 10/722,393

(22) Filed: Nov. 28, 2003

(51) Int. Cl. G09G 5/00

(52) U.S. Cl. 345/3.2

(57) ABSTRACT

The invention provides a system and method for processing frames of images. The system and method are embodied to: identify a frame in an image frame; extract a component element from the frame; generate a subindex related to the index for the element; and distribute the element and the subindex to a frame recorder in a series of data streams. At the frame recorder, the data streams are received and a reconstructed image series representing the image series is constructed.

### FIELD OF THE INVENTION

The invention relates to a system and method for processing frames of images, in particular, filmed images captured at high frame rates.

### BACKGROUND OF INVENTION

Typical motion picture presentation utilises projection of a film print captured and displayed at 24 frames per second (fps). Projection of film captured at 24 fps may exhibit motion-based artefacts, including print weave, jitter and strobing on horizontal movement (the latter typically being very noticeable).

One method used to correct motion-based artefacts is to alter individual frames using digital image processing techniques. However, it is difficult and costly to remove strobing and frame rate-related artefacts using such techniques.

An alternative method is to capture and project a motion picture using a film print captured and displayed at 48 fps. The higher frame rate provides a projected image which is smoother and has better apparent resolution and contrast than a projected image captured and displayed at 24 fps. Benefits of high frame rate presentation are discussed in U.S. Pat. No. 4,477,160, including:
Higher apparent resolution
Higher apparent contrast ratio
Fewer motion artefacts
More natural look to the image

However, capturing images at 48 fps requires twice as much film than images captured at 24 fps, making it an expensive alternative. Further, processing images captured at 48 fps requires expensive processing and storage equipment compared with more readily available processing equipment for images captured at 24 fps. There is a need for a system for processing of high resolution filmed images which better utilises existing processing technology.

### SUMMARY OF INVENTION

In a first aspect, a system for producing digital data streams from an image series of frames is provided. The system is connectable to a feed of digital data containing the image series. The image series is captured at a capture frame rate. The digital data streams collectively contain the digital data of the image series at a lower rate. The system comprises a frame processing module which has an input port connected to the feed; a processing device for file format conversion of the frames of the feed; output ports for transmitting from the system a set of output streams; and a processing module. The processing module has a first module for identifying a frame in the feed and for identifying an index associated with the frame; a second module to split the image series into component elements, associate each element with a subindex related to the index and distribute the elements as data amongst the output ports in a distribution pattern.

The system may further comprise a frame recorder for receiving data in the output ports and constructing a recombined image series from the data. The recorder may have input ports associated with the output ports; a data transfer module element associated with each input port; an image reconstruction module to read data arriving from the input ports in a manner governed by the distribution pattern, to extract component elements and subindex information contained therein and to generate the recombined image series utilising the component elements and subindex information by controlling the data transfer module of each input port to selectively transfer the data arriving from the input ports to produce the recombined image series; and an output port for transmitting the recombined image series from the frame recorder.

In the system, the frame processing module may further comprise a storage device for the image series and the processing module therein may further comprise a third module for directing the frames to the storage device while processing the image series and for providing the component element from the storage device to the second module when the second module is distributing the component element to a port.

In the system the capture rate may be forty-eight (48) frames per second, the lower rate may be twenty-four (24) frames per second, the digital data streams may be two data streams and there may be two output ports.

In the system the frame recorder may further comprise a module for generating an edit copy of the image series. The edit copy may have an edit frame rate which is lower than the capture rate.

In the system the processing module may comprise a first buffer associated with the input port for storing the frames and a second buffer associated with the plurality of output ports. Further, the frame may be moved from the first buffer to the second buffer as they are fully received by the frame processing module.

In the system, the distribution pattern may comprise providing one frame of said image series to the first port and providing the next frame of said image series to said second port.

Alternatively, in the system, the distribution pattern may comprise providing one line of a frame of the image series to the first port and providing the next line of the frame to the second port.

In a second aspect, a method of processing an image series of frames captured at a capture frame rate is provided. The method comprising the following steps:
a) identifying a frame in the image frame and an index associated with the frame;
b) extracting a component element from the frame;
c) generating a subindex related to the index for the component element;
d) distributing the component element and the subindex to a frame recorder in a data stream to one of a series of output ports according to a distribution pattern, each port transmitting at a data rate lower than the capture frame rate; and
e) at the frame recorder, receiving all data streams from the output ports and constructing a reconstructed image series representing the image series utilizing the all data streams and storing the reconstructed image in a database.

The method may further comprise the step of
f) generating an edit copy of the image series from the reconstructed image produced by accessing the recontructed image and dropping one frame or field from the image series from the edit copy at a periodic interval, the edit copy having an edit frame rate which is lower than the capture frame rate.
   Further, in the method in step f), the periodic interval may comprise dropping every second frame from the image series.

Alternatively, the method may comprise the step of
f) generating an archive copy of the image series by accessing the reconstructed image and providing each frame of the reconstructed image to the archive copy, the archive copy having an archive copy frame rate which is lower than the capture frame rate.

The method may further comprise editing the archive copy to create a presentation master copy of the image series, the presentation master copy having a presentation frame rate of the archive copy frame rate and creating duplication copies of the presentation master copy, each of the duplication copies having a duplication frame rate of the presentation frame rate; and displaying one of the presentation master copies at a theatre at the capture frame rate.

In the method in step c), the subindex may be a temporal equivalent identifier for the component element.

In the method, the archive copy may be provided with an edit decision list representing translated edit points relating to the image series.

In the method, the presentation master copy may be provided with an edit decision list representing edit points relating to the image series.

In the method in step g), the editing may comprise editing the archive copy to introduce editing changes relating to one of editorial, compositing and colour correction edits.

In the method in step g) the duplication copies may comprise digitized images of frames.

In the method, the component element may comprise the frame entirely. It may also comprise a field of the frame.

In the method, in the capture frame rate may be 48 fps, the edit frame rate may be 24 fps, the archive copy frame rate may be 24 fps and the duplication frame rate may be 24 fps.

In the method, the edit decision list for the edit copy may reflect an edit point for every other frame of the image series for the presentation copy.

In other aspects of the invention, various combinations and subset of the above aspects are provided.

### BRIEF DESCRIPTION OF THE DRAWINGS

The foregoing and other aspects of the invention will become more apparent from the following description of specific embodiments thereof and the accompanying drawings which illustrate, by way of example only, the principles of the invention. In the drawings, where like elements feature like reference numerals (and wherein individual elements bear unique alphabetical suffixes):

FIG. 1 is a block diagram of a system comprising a camera, a frame processor illustrating an embodiment and a frame recorder;

FIG. 2 a block diagram illustrating further detail of the frame processor of FIG. 1;

and

FIG. 3 a block diagram illustrating further detail of the frame recorder of FIG. 1.

### DETAILED DESCRIPTION OF THE EMBODIMENTS

The description which follows, and the embodiments described therein, are provided by way of illustration of an example, or examples, of particular embodiments of the principles of the present invention. These examples are provided for the purposes of explanation, and not limitation, of those principles and of the invention. In the description which follows, like parts are marked throughout the specification and the drawings with the same respective reference numerals.

Generally, the invention relates to a process and system providing improved image capture and presentation for digitally projected motion pictures or “D-Cinema”. The process involves capture and presentation of images at 48 fps, i.e. twice the normal frame rate of 24 fps, resulting in significant improvements in apparent resolution and contrast, while at the same time reducing the impact of motion artefacts on the viewer.

Typically, there are exposure and cost issues with 48 fps capture. First, with 48 fps capture the exposure time for the film image is half that of 24 fps capture. Previously, if 48 fps capture were used, it required additional lighting arrangements over and above arrangements needed for the 24 fps capture. However, use of currently available fine grain, high speed film stocks has overcome this issue. Second, 48 fps capture (using conventional Academy 4×3 film frame which is also known as 1:1.33 aspect ratio film and “4 pref” film) requires twice the film stock per second of recorded images compared with 24 fps capture. The amount of film stock used may be reduced by using wider aspect ratios more in keeping with typical presentations for motion pictures. For example, the standard presentation ratio for cinema release is 1:1.85, which can be captured in a “3 perf” high image on film. This produces a 25% film stock saving over normal Academy framing. Similarly, wide screen presentations are presented in a 1:2.35 ratio, which can be captured in a “2 perf” format. Whether captured in an Academy format or wide-screen ratio, 48 fps captured images will provide a superior viewing experience.

An additional benefit of the process is that when the capture medium is film, many cameras are currently capable of 48 fps photography, thereby making initial capture on film a simple process. Also, the process uses many widely used motion picture production processes, thereby reducing training and retooling issues while still providing significant improvements in image quality.

Briefly, the process is as follows. After completion of photography for a day, the film is processed in the normal manner. Dailies are produced by transferring original camera negative (OCN) using either: a telecine with an expanded frame store and capable of streaming 48 frames per second; or a conventional telecine at half-capture speed (or 24 fps) recorded at 24 fps. Subsequently, the dailies are recorded to a digital disk recorder (DDR) at either at 48 fps or 24 fps (using a conventional telecine at half capture speed or 24 fps). In either case the DDR should have the following capabilities: to record at any given frame rate and to play out at another; and to play out every second frame or every second field. The latter capability enables screening of images captured at 48 fps without temporal changes to the images using conventional video systems displaying images 24 fps.

Screening and creative editorial copies may be made from the DDR. In particular 24 fps copies may be made from the 48 fps images by dropping every second frame or field from the 48 fps stream and recording the result to a conventional video format at 24 fps. If standard definition copies are required, down conversion and addition of a 3:2 pull down may be used for compatibility. It will be appreciated that all copies made in this manner are temporally identical to the 48 frame original. “Off-line” processes may be conducted following traditional post-production path. All copies used for creative editorial using outputs of other edit systems are fully compatible with those systems and fully represent the original. At this point the material on the DDR may be archived to conventional high-definition (HD) tape formats (such as D5or D6) or data archive tape (such as DTF2 or DST). As many DDRs have removable drives, archive of the original digital transfer may be kept on removable drives for later use.

Once all dailies screenings and creative editorial are complete, the list generated by the edit system needs to be converted from 24 frame to 48 frame. This list translation may be conducted by a computer program which converts each field to a frame. For example, if the 24 frame edit list event was at timecode 1 hour: 2 minutes: 10 seconds: 8 frames: 1 field (assuming a 1 hour starting code on the roll), then the new code for the event would be 1 hours: 4 minutes: 20 seconds: 17 frames: 0 fields. As such, 48 frame original material may be edited on conventional HD editorial systems at 24 fps, providing cost effective post-production of the 48 frame material. Even if creative editorial is executed on a standard definition 30 fps based system, existing conversion programs provide conversion from 30 fps lists to 24 fps lists. Therefore, material archived to conventional 24 psf (progressive scan format) based HD video is now fully compatible with the “creative edit” edit list.

From this point in the post production path further processing may take place in a 24 fps environment. As editorial, colour correction, compositing etc. remain at 24 fps, motion will appear to be at half speed in the image. Therefore if audio synchronization requires checking, scene transitions require evaluation, viewing at full speed is required, an operator may use a “vary speed” function available on most tape or disc based HD video players.

Upon completion of final editorial and assembly, material may be transferred back to the DDR. Once again, as the DDR is capable of recording at 24 fps and playback at 48 fps this is now the final master that will be used for duplication or electronic distribution at 48 fps.

The final master may be distributed to theatres through many means including, satellite transmission, fibre transmission and physical distribution of discs. At the theatre the play-out device should support 48 fps in a psf mode. This will provide a viewer with 96 “image impressions” per second. As noted in U.S. Pat. No. 5,627,614 doubling of image impression projection reduces flicker. The play out device in the theatre should support a refresh rate of 96 Hz and a 48 frame rate. Although this process is fully compatible with a rate of 48 fps at full frame progressive, the preferred method is to use a psf format for 96 image impressions per second. Many projection systems are available that are capable of 48 fps at 96 Hz. If the projection system is capable of 48 fps but not 96 Hz, then the image material may be distributed to that theatre at a rate of 48 p as opposed to 48 psf. Alternatively, if the material is distributed at 48 psf, a simple frame store as is known in the art may be used to convert the 48 psf format to 48 p for presentation.

If the original images are captured electronically instead of on film, the digital camera preferably uses a frame store to facilitate recording of 48 fps images to a DDR. Frame stores are widely used in the art in both electronic cameras and telecines to hold raw data in memory while a processing device converts the raw data from a previous frame or field into a conventional video format so that it may be recorded or viewed. Using this same basic concept, but with a much larger store than the 2 to 4 fields conventionally used, two a high-definition serial digital interface (HD-SDI) streams may be used to transport 48 fps HD in real time to the DDR. In order to accomplish this the frame store needs to hold the raw data from the camera pick-up and allow time for conversion to the HD video format, as well as allow for enough fields to be in queue to facilitate the real time transfer of the 48 frame HD video to the DDR. To accomplish this the frame store should hold at least six fields, but ideally five full frames or fields should be held.

The frame store loads at a rate of 48 fps and discharges at rate of 48 fps but uses two HD streams. Each stream transports one frame to the DDR at a rate of 24 fps but because the two frames, one on each stream, are only one line apart in time the effective transfer rate is 48 fps. The one line temporal separation allows the DDR to place each frame in proper sequence. For this invention the DDR must be dual headed to record two frames simultaneously. Once recorded to the DDR the process path is the same as described for film capture.

As previously described, in order to transfer film originated material in real time at 48 fps the telecine must be modified with a frame store as described above or have one as described as native.

It has been suggested that images projected at 24 fps have a “cinematic look”, involving motion blur and flicker, which contribute to a suspension of disbelief for motion pictures. This “cinematic look” can be maintained with this process, without the introduction of objectionable motion artefacts. Since the presentation master is electronic, introduction of motion blur and a slight flicker at the rate of every second frame may provide “cinematic look” to an image if desired.

A feature of the process is that for home video (or even broadcast distribution) the 48 fps master from DDR plays out every second frame to create a true 24 fps HD video master. This 24 fps master may then be used to create distribution masters for home video or broadcast. Again, because 24 fps is compatible with all video and broadcast standards the 48 fps master provides a universal format.

It will be appreciated that the process of 48 fps image capture and presentation in “D-Cinema” provides a smoother, higher contrast, higher resolution image than is currently available for “D-Cinema”. The process provides a cost-effective system which is compatible with video and broadcast standards, in part by using existing production and post production techniques.

Conventional equipment may be used except for modified electronic cameras and telecines.

Briefly, following is an exemplary production path using the system.
1) All photography is captured at 48 fps.
2) After photography for each day is complete, film is processed in a normal manner.
3) Dailies are provided electronically via HD telecine with a customized frame store to allow for full 48 fps play out. This is recorded to a HD DDR at 48 fps.
4) Dailies may be screened directly from the DDR at 48 fps, as shot, or a 24 fps copy may be made for screening purposes.
5) A 24 fps copy is made by playing out every second frame from the DDR 48 fps master for ingestion into a conventional edit system.
6) From the 24 fps edit copy, usual viewing copies are made.
7) 48 fps material on the DDR is archived to a standard 24 p HD tape by playing out every frame of the 48 fps sequence but at a speed of 24 fps. This archive master may be used as an element for final edit and colour correction.
8) Once principal photography and creative editorial are complete, archive masters are used to make a final presentation master. All processes at this time are the same as conventional editorial, compositing and colour correction, except at half the normal speed. If a “cinematic look” is desired, motion, blur, and slight flicker may be added. During this process, the material may be viewed at full speed by adjusting the speed function on the tape system.
9) When normal post production processes are complete, the master is copied to a DDR at a rate of 24 fps (or half speed) to produce a duplication master for final distribution.
10) The distribution copies are made utilizing a data format compatible with the high-resolution graphics card or device.
11) Once in the theatre, a 48 fps distribution copy is played out to a digital projection system at 48 fps for presentation.

The production path may also be used with electronically captured material by simply moving directly from image capture to dailies duplication and viewing.

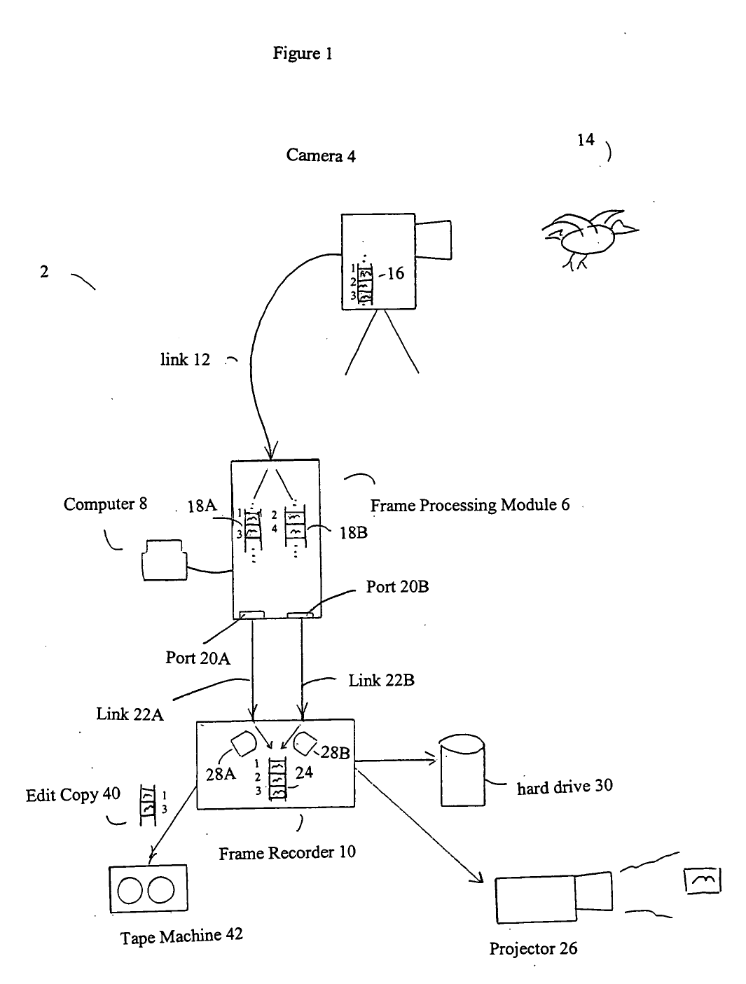

Referring to FIG. 1, an embodiment of the invention is provided illustrative of a specific implementation of the process and system. Therein, system 2 comprises camera 4, frame processing module 6, computer 8, and frame recorder 10. Camera 4 is connected to frame processing module 6 via digital data link 12, which is preferably a low voltage differential signal (LVDS) connection. However, it will be appreciated that any connection and encoding format capable of carrying digital (or appropriate analog) signals would be acceptable for link 12 as long as it does not substantially degrade the transmission speed or quality of the data carried therein.

Camera 4 is preferably capable of capturing images at 48 fps, although other cameras having other capture rates may be used. Camera 4 may be a digital camera or any other device capable of capturing or producing a series of digital images from a filmed or live source. For example, camera 4 may be a telecine, which converts the format of a motion picture film into a television broadcast format. An exemplary digital camera is a Viper Filmstream Camera (trade-mark of Thompson). Alternatively, an analog film camera may be used to capture the 48 fps images and the film could be processed by a device (not shown) to convert the images to a digital format for use with this embodiment.

As shown, camera 4 is being used to capture an image of flying bird 14. The moving image of bird 14 is captured by camera 4 as a series of frames or digital images, represented notionally as a series of “film frames” as image series 16. An exemplary digital frame may have a pixel resolution of 1080×1920 and may be encoded in 10-bit YUV or RGB colour. Other resolutions may also be used. In image series 16, each frame is numbered and tracked by an index. As shown, index numbers “1”, “2”, “3” and “4” are associated with each frame in a digitized code; however, it will be appreciated that other indexing systems may be used instead. Camera 4 can provide each digital image and its associated index information as digital data to link 12.

Frame processing module 6 provides processing and conversion of the data stream of frames provided by camera 4 into a number of subordinate data streams. In the embodiment, frame processing module 6 generates two 24 fps data streams 18A and 18B and associated indices from image stream 16. In other embodiments, a frame processing module may generate three or more data streams.

Computer 8 is connected to frame processing module 6 and is contains software operating thereon (not shown) which reads the index information associated with the image series 16 and produces the two separate data streams 18A and 18B and the associated indices. It will be appreciated that computer 8 may be a stand-alone unit separate from frame processing module 6; alternatively, operational elements of computer 8 may be provided within frame processing module 6. Such operational elements would include a microprocessor (not shown), memory storage (not shown) and a program (not shown) operating on the microprocessor.

Although frame processing module 6 is shown as a separate module which may be mounted to a rack (not shown), in other embodiments an alternative frame processing module may be physically incorporated into camera 4.

Data streams 18A and 18B are generated by frame processing module 6 by receiving each frame from image series 16 and then providing one frame to one data stream and the next frame to the other data stream. As such, using the four frames shown for image stream 16, using this frame translation algorithm, data streams 18A and 18B are populated using the following sequential distribution pattern of images:
First frame at index “1” is populated in data stream 18A,
Then frame at index “2” is populated in data stream 18B,
Then frame at index “3” is populated in data stream 18A, and
Finally frame at index “4” is populated in data stream 18B.

Each data stream 18 has a data port 20 associated with it. Each data port 20 transmits each data stream 18 to an external device connected to frame processing module 6; here the external device is frame recorder 10, which is a digital data recorder (DDR). In the embodiment, each data port 20 is adapted to transmit each data stream 18 as a HD-SDI stream. Data ports 20A and 20B are connected to data link 22A and 22B, respectively. As a result, data ports 20A and 20B collectively carry the images of the original image series 16 in two separate streams, each stream carrying every second frame of the original image series at a frame rate of 24 fps, the frames in each stream being offset from each other by one frame. Collectively the data streams 18A and 18B provide the original image series 16 at 48 fps. (For other embodiments generating three or more data streams, there will be a data port 20 and a data port 22 associated with each stream and the frames may be distributed amongst the streams in some predetermined order.)

To process frames, frame recorder 10 reads each frame and its index received from each data port 20. Frame recorder 10 then reconstructs image series 16 into recombined image series 24 utilising the indices to determine a reconstruction order for the received frames. As shown in FIG. 1, the frame sequence of recombined image series 24 is identical to the frame sequence of the image series 14. As recombined image series 24 is produced, frame recorder 10 stores the digital data related to it onto a non-volatile storage device. Also, film copy of recombined image series 24 may be produced by frame recorder 10. Frame recorder 10 is connected to digital projector 26 to project recombined image series 24 to a projection screen (not shown).

If required, a 24 fps film copy may be made for conventional film screening, by frame recorder 10 playing out every other frame to a film recorder such as an Arri Laser system (trade mark of Arnold & Richter Cintechnik, Munich, Germany). This will allow the production to be screened in theatres not equipped with 48 fps digital projection.

The one-frame temporal separation of frames in data streams 18A and 18B simplifies reconstruction of recombined image series 24 in the original sequence. To facilitate the reconstruction, in frame recorder 10, data transfer modules 28A and 28B are associated with each data stream 18A and 18B. Figuratively, each data transfer module 28 is a recording head which digitally transfers each frame from each data stream 18 to recombined image series 24. Each data transfer module 28 is controlled by frame recorder 10 to alternatively and continuously transfer a frame from a data stream 18 (A or B) onto the recombined image series 24, based on the index of the received image and the frame rate of data streams 18. Although recombined image series 24 is illustrated as a unified set of images on a “film”, in the embodiment, recombined image series 24 is a digitised set of images. As the set is large, the storage device is preferably a secondary storage device, such as hard drive 30. The data set may be distributed amongst a set of hard drives, with segments of each frame of image series 24 being distributed in a predetermined manner across the members of the set of drives. For example, parts of a frame in image series 24 may be stored amongst selected drives in the set of drives. Each stored frame is associated with an index to enable the set of frames to be recombined in the proper order when extracted from the set of drives. Alternatively the storage device may be RAM or flash memory. Data transfer modules 28 may be controlled by a hard-wired control circuit to record each frame from each data stream 18 into a single stream, by successively taking alternating frames from each data stream; alternatively, data transfer modules 28 may be controlled by a procedure operating on computer 8.

It will be appreciated that without frame processing module 6, image series 16 would have to be recorded and processed at its raw frame rate, i.e. 48 fps, requiring a frame recorder to process images at that same rate. This would require image processing equipment which is more costly than more readily available image processing equipment, such as 24 fps based technologies used in frame recorder 10.

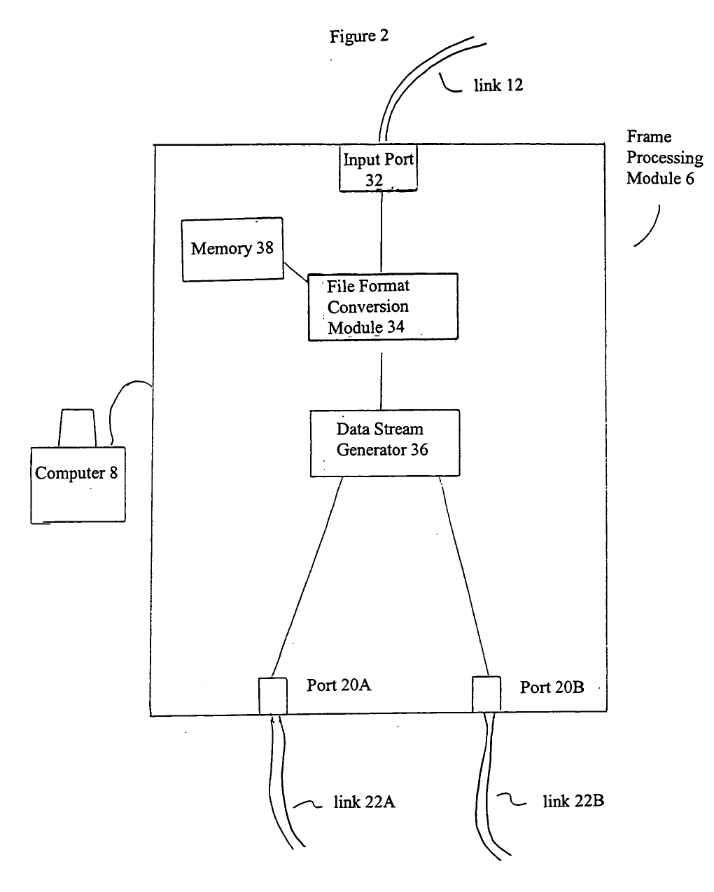

Referring to FIG. 2, further detail on frame processing module 6 is provided. Frame processing module 6 further comprises port 32, file format conversion module 34 and data stream generator 36. Port 32 receives the image series 16 and provides it to file format conversion module 34, which receives the raw data (either as a RGB file or a SMPTE HD file), identifies individual fields, frames therein and adds to the data stream a timestamp. In the embodiment the timestamp is an absolute frame indicator following the RP 215 standard. Using the index information generated for image series 16 by conversion module 34, data stream generator 36 generates separate data streams 18A and 18B from each frame of image series 16 by splitting image series 18 into a series of frames and then providing each frame to one of the data streams 18 in an alternating frame pattern.

In other embodiments, instead of using single frames as component elements of image series 16, other component elements of image series 16 may be used to determine how elements of image series 16 are transferred into data streams 18. For example, a block of n frames may first be provided to data stream 18A and then a next block of n frames may be provided to data stream 18B, where n is any positive integer. Alternatively, each data stream 18 may be filled by sections of a frame, e.g. alternating fields. A frame may be progressive or composed of two fields.

In other embodiments, frame processing module 6 may incorporate appropriate hardware to generate three or more data streams from image series 16. Sufficient memory and data processing capacity is provided such that the population rate for the number of generated data streams keeps pace with the input rate of frames from image series 16. Further still, in other embodiments, image series 16 may be provided to frame processing module 6 at other frame rates, e.g. 30 fps, 96 fps or others.

Data stream generator 36 also generates a subindex for each frame of image stream 16 and encodes it into each data stream 18. As shown, in FIG. 1, each subindex is a copy of the index of the frame transposed from image stream 16. In the embodiment, the index and subindex are timestamps. It will be appreciated that other indexing schemes may be used. For example, each data stream 18 may use a combination of alphanumeric characters in defined sequence to identify each frame, e.g. A1, B1, A2, B2 etc. Other schemes may be used to identify lines of frames or fields, when other transfer algorithms are used.

It will be appreciated that in order to process image series 16 in a real-time fashion, frame processing module 6 must be able to generate data streams 18A and 18B in real-time without dropping any frame from image series 16 and to produce data streams 18 at a rate which does not lag the rate of arrival of frames in image series 16. As noted, image series provides frames to frame processing module 6 at a rate of 48 fps. When a full frame is received by frame processing module 6, it provides the frame to data stream generator 36, where the raw data in the frame is converted to a SMPTE formatted HD stream. As the egress transfer rate of a SMPTE-formatted HD stream is 30 fps, two ports 20 collectively provide sufficient transmission bandwidth to maintain the frame rate of the images in the image series.

To assist in maintaining a sufficient generation rate of data streams 18, frame processing module 6 is provided with memory 38 having sufficient storage to buffer a sufficient number of frames of image series 16. In the embodiment, memory 38 is used to provide two stages of buffering. The first stage is a buffer for frames received from link 12. The second stage is for frames being transmitted by ports 20. The first stage buffer has the capacity to store at least one frame; the second stage buffer has the capacity to store at least two frames. Memory 38 is preferably internal to frame storage module 6 and is preferably embodied as a form of electronic storage, such as RAM. However, it will be appreciated that any memory storage system, whether local or remote to frame storage module 6, e.g. a disk drive, may be used if the storage and extraction process thereto keeps pace with the rate of reception of frames in image series 16. As well, frame processing module 6 is provided with sufficient processors and computational capacities to perform the necessary frame identification, storage, extraction and index generation for the image series 16 and data stream 18A and 18B.

To illustrate the storage and transfer of frames amongst image stream 16, memory 38 and data streams 18, an example is provided where three sequential frames in an exemplary image stream 16 are processed by frame processing module 6. To begin, when the first frame in the image series is received by frame processing module 6, it is provided to the first buffer in memory 38. Once the frame is received, module 6 extracting the first frame from the first buffer and provides it to the second buffer. Identification module 34 reads the index information associated with the first frame and determines that the first frame should be provided to data port 20A. Thereafter, portions of the first frame are sequentially extracted from the second buffer, a sub-index is generated by data stream generator 36 and the frame is provided to data port 20A for transmission. Meanwhile, the second frame is being received by module 6 in the first buffer. When the second frame is received, it is transferred from the first buffer to the second buffer. Identification module 34 reads the index information associated with the second frame and determines that it should be provided to data port 20B. At that time, as data port 20A transmits data at 24 fps (i.e. half the rate of image series 16), only half of the first frame will have been extracted from the second buffer and transmitted to port 20A. As port 20A transmits the remainder of the first frame, data stream generator 36 begins extracting the second frame from the second buffer, generates a sub-index for it and provides it to port 20B for transmission. Meanwhile, the third frame is being received by module 6 in the first buffer. When the third frame is fully received is it transferred from the first buffer to the second buffer. (At that time, the first frame has been fully extracted from the second buffer and transmitted to port 20A, providing room for the third frame in the second buffer). Identification module 34 reads the index information associated with the third frame and determines that it should be provided to data port 20A. At that time, port 20B is still transmitting the second frame, but port 20A is idle. As such, data stream generator 36 begins extracting the third frame from the second buffer, generates a sub-index for it and provides it to port 20A for transmission.

It will be appreciated that in other embodiments, the processing capabilities, the speed the components and the number of data stream being generated may reduce, eliminate or even increase the size of the buffer required to maintain a frame rate when splitting image stream 16 amongst the allocated number of data streams 18. Further, alternative algorithms used to identify and transfer component elements of image stream 16 into the data stream 18 may also affect the need for buffering. For example, if component elements of an image are divided using fields of an image, it may be necessary to store five image frames in the buffer. This is due to the interlaced relationship between fields for a frame.

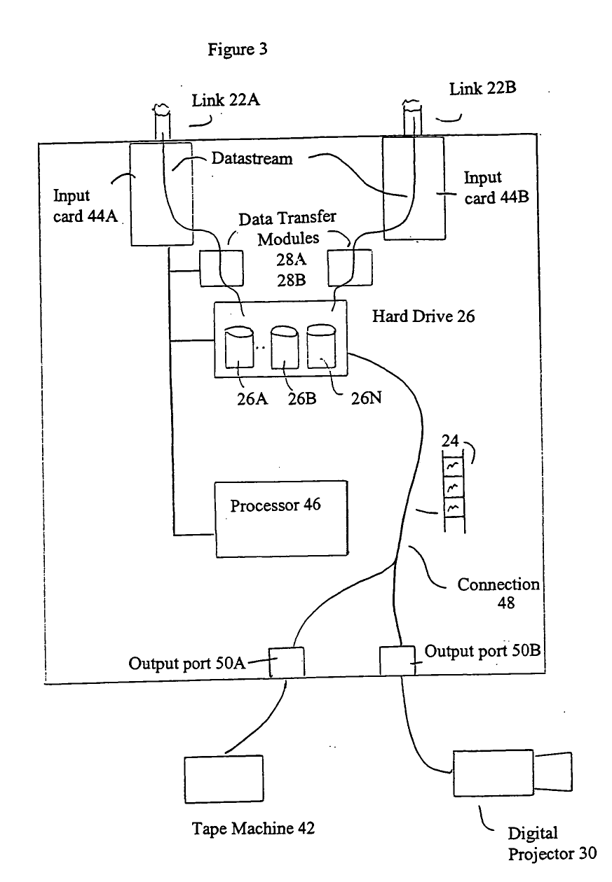

Referring to FIG. 3, further detail on frame recorder 10 is provided. In addition to data transfer modules 28A and B and hard drive 30, frame recorder 10 further comprises input cards 44A and 44B; input card 44A receives the data stream carried on link 22A and input card 44B receives the data stream carried on link 22B. Each input card 22 converts the received data stream into a format which can be internally used and processed by frame recorder 10. Processor 46 (and its software) controls operation of the input cards 22 and other operational aspects of frame recorder 10. As each input card processes its received data stream, the individual frames contained therein are buffered in storage. Preferably, the storage is located within ready access to the input card. Data transfer modules 28 are controlled by processor 46 in synchronising their writing of data streams received by input cards 44. As noted earlier, data transfer modules 28 may be synchronised to distribute portions of their related data streams amongst several sub-hard drives 30A, 30B, . . . 30B in hard drive 30. Processor 46 controls the extraction of the portions from hard drives 30 to generate recreated image stream 24 for transmission to connection 48 for transmission to output ports 50. Output port 50A is connected to tape machine 42 and converts image stream 24 into a format which can be carried onto a connection from frame recorder 10 to tape machine 42. Similarly, output port 50B is connected to digital projector 30 and converts image stream 24 into a format which can be carried onto a connection from frame recorder 10 to projector 30.

The embodiment also provides a cost-effective method of providing post-production for images originally captured at a high definition frame rate (such as 48 fps) by enabling creation of edit copies of images generated at a lower frame rate (such as 24 fps). As the edit copies are provided at a lower frame rate than the original captured images, the edit copies utilise less storage (for the embodiment described, half as much film) as the original high-definition image. For example, in a typical movie production, a 48 fps film camera may be used to provide a higher quality capture of the scenes. Typically at the end of a day, the film of the day's series of scenes is developed. Subsequently, the film is provided to camera 4 to produce a digital copy of in image series 16 at 48 fps. Using the embodiment, image streams 18A and 18B are recorded to frame recorder 10. As frame recorder 10 is a DDR and is capable of recording at many frame rates and playing out at many different frame rates, frame recorder 10 can be used to generate a 24 fps copy which may be used in creative edit or for screening purposes. Frame recorder 10 may generate this copy by playing out every second frame or field of the image stream such that a temporally accurate 24 fps copy of the 48 fps original image stream is created. At this point, the 24 fps copy may be edited using a 24 fps film editing system, such as an Avid Film Composer (trade-mark of Avid Technology, Inc.). This 24 fps copy may also be used to make viewing copies for distribution to production.

Frame recorder 10 may also create an archive copy for final post-production and generation of a final presentation master. The archive copy is made by the DDR playing out all image frames in sequence at half of the original 48 fps rate. This playout (at 24 fps in this case) allows for use of conventional 24 fps recorders (either disc-based or tape-based). Having an archive master at 24 fps also allows for use of conventional post-production tools to perform final edit, compositing and colour correction required to produce the final presentation master.

In order to effectively use the archive copy in the final post-production process, recalculation of the index values or timecodes must be performed. As the 24 fps edit copy is temporally the same as the original 48 fps captured material, the 24 fps copy will have the same time signature as the captured material. However, the code for the edit copy will be 24 frame-based instead of 48 frame-based for the captured material. As such, if the original timecode signature at 48 fps was:

1 hour: 2 minutes: 10 seconds: 9 frames, then the matching timecode on the 24 fps edit copy would be:

1 hour: 2: minutes: 10 seconds : 4 frames: 1 field.

As only every second frame or field is used to make the edit copy, only even-numbered frame counts may be used with the addition of a single field representing the odd-numbered frames of the original. This above example assumes that the one-hour marker is the roll signature.

In order to utilize the edit decision list generated through the use of the edit copy, a list translation should be performed. This translation is necessary as the archive copy which is used to make the final presentation master will be required to carry valid 24 fps timecode to maintain compatibility with conventional editing and compositing systems. As such, if the original 48 fps code was:

1 hour (designating roll #1): 2 minutes: 10 seconds: 9 frames, then the 24 fps compatible code used on the archive copy would be:

1 hour: 4 minutes: 20 seconds: 18 frames.

As such, if an edit point is shown on the edit decision list (EDL) from the edit copy at:

1 hour: 2 minutes: 10 seconds: 4 frames: 1 field, then the edit point on the master using the 24 fps half speed archive copy would be:

1 hour: 4 minutes: 20 seconds: 9 frames.

Although generation of the timecodes used in both the edit copy and the archive copy are generated at the same time the copies are made, using conventional timecode generation equipment the codes by necessity must be different. Timecodes and their use are known in the art.

In order to allow for a frame-accurate conformation of the archive copy, the edit copy edit decision list must be translated to match the half speed code on the archive copy. This may be accomplished by utilizing a computer program to perform the translation.

Although the embodiment describes a transcription system which converts images filmed at 48 fps into an image at 24 fps, it will be appreciated that other systems may be provided which use different input frame rates, such as 96 fps or 72 fps and different output rates, such as 30 fps. Appropriate conversion of input to output frame rates would be provided by such systems. It is notable that if the editing is performed on a 30 fps based system, it is possible to use known data conversion software which will convert the 30 fps list to 24 fps list. It will be appreciated that all finish editing, colour correction, compositing, etc., remains at 24 fps. As such, all motion will look to be at half-speed (compared with the encoded 48 fps images). Utilising the embodiment, post-production may be conducted as follows. Initially, all photography is done using film or video captured at 48 fps. It is noted that further cost savings may be derived by using film formats having aspect ratios which capture all of the viewable screening area and capture as little of an area outside the viewing area as possible. Most theatrical motion picture presentations have a wide aspect viewing ratio of either 1.85:1 or 2.35:1. As such, use of 35 mm filmstock at 3 perf high or 2 perf high format would provide full capture of all viewable screen area and be more economical to use. As was described earlier, full Academy aspect ratio is 1:33:1 or 4 by 3.

It will be appreciated edits made to an edit copy using the embodiment may also be made to an archive copy and vice versa.

It is noted that those skilled in the art will appreciate that various modifications of detail may be made to the present embodiment, all of which would come within the scope of the invention.

1. A system being connectable to a feed of digital data of an image series of frames captured at a capture frame rate for producing a plurality of digital data streams collectively containing said digital data of said image series at a lower rate, said system comprising:
a frame processing module having
an input port connected to said feed;
a processing device for file format conversion of frames of said feed;
a plurality of output ports for transmitting from said system a set of output streams; and
a processing module having
a first module for identifying a frame in said feed and for identifying an index associated with said frame;
a second module to split said image series into a plurality of component elements, to associate each element of said component elements with a subindex related to said index and to distribute said plurality of component elements as data amongst said plurality of output ports in a distribution pattern.

2. The system of claim 1 further comprising
a frame recorder for receiving said data in said plurality of output ports and constructing a recombined image series of said image series from said data, said frame recorder having
a plurality of input ports associated with said plurality of output ports;
a recording element associated with each input port of said plurality of input ports;
an image reconstruction module to read data arriving from said plurality of input ports in a manner governed by said distribution pattern, to extract component elements and subindex information contained therein and to generate said recombined image series utilising said component elements and subindex information by controlling said recording element of said each input port to selectively transfer said data arriving from said plurality of input ports to produce said recombined image series; and
an output port for transmitting said recombined image series from said frame recorder.

3. The system of claim 2 wherein
said frame processing module further comprises a storage device for said image series, and
said processing module further comprises
a third module for directing said frames to said storage device while processing said image series and for providing said component element from said storage device to said second module when said second module is distributing said component element to said one port.

4. The system of claim 3 wherein said capture rate is forty-eight (48) frames per second, said lower rate is twenty-four (24) frames per second, said plurality of digital data streams are two data streams and said plurality of output ports comprise a first port and a second port.

5. The system of claim 4 wherein said frame recorder further comprises a module for generating an edit copy of said image series, said edit copy having a edit frame rate which is lower than said capture rate.

6. The system of claim 5 wherein
said processing module device further comprises:
a first buffer associated with said input port for storing said frames; and
a second buffer associated with said plurality of output ports; and
said frames are moved from said first buffer to said second buffer as they are fully received by said frame processing module.

7. The system of claim 6 wherein said distribution pattern comprises providing one frame of said image series to said first port and providing the next frame of said image series to said second port.

8. The system of claim 6 wherein said distribution pattern comprises providing one line a frame of said image series to said first port and providing the next line of said frame to said second port.

9. A method of processing an image series of frames captured at a capture frame rate comprising steps of:
a) identifying a frame in said image frame and an index associated with said frame;
b) extracting a component element from said frame;
c) generating a subindex related to said index for said component element;
d) distributing said component element and said subindex to a frame recorder in a data stream to one output port of a plurality of output ports according to a distribution pattern, each of said plurality of output ports transmitting at a data rate lower than said capture frame rate;
e) at said frame recorder, receiving all data streams from said plurality of output ports and constructing a reconstructed image series representing said image series utilizing said all data streams and storing said reconstructed image in a database.

10. The method of processing an image series of frames as claimed in claim 9, said method further comprising
f) generating an edit copy of said image series from said reconstructed image produced by accessing said recontructed image and dropping one component element from said image series from said edit copy at a periodic interval, said edit copy having an edit frame rate which is lower than said capture frame rate.

11. The method of processing an image series of frames as claimed in claim 10, wherein in said step f) said periodic interval comprises dropping every second component element from said image series.

12. The method of processing an image series of frames as claimed in claim 9, said method further comprising
f) generating an archive copy of said image series by accessing said reconstructed image and providing each frame of said reconstructed image to said archive copy, said archive copy having an archive copy frame rate which is lower than said capture frame rate.

13. The method of processing an image series of frames as claimed in claim 12, said method further comprising
g) editing said archive copy to create a presentation master copy of said image series, said presentation master copy having a presentation frame rate which is equivalent to said archive copy frame rate;
h) creating a plurality of duplication copies of said presentation master copy, each of said plurality of duplication copies having a duplication frame rate which is equivalent to said presentation frame rate; and
i) displaying one of said plurality of presentation master copies at a theatre at said capture frame rate.

14. The method of processing an image series of frames as claimed in claim 13, wherein in said step c) said subindex is a temporal equivalent identifier for said component element.

15. The method of processing an image series of frames as claimed in claim 14, wherein said archive copy is provided with an edit decision list representing a translated edit points relating to said image series.

16. The method of processing an image series of frames as claimed in claim 15, wherein said presentation master copy is provided with an edit decision list representing edit points relating to said image series.

17. The method of processing an image series of frames as claimed in claim 16, wherein in said step g) said editing comprises editing said archive copy to introduce editing changes relating to one of editorial, compositing and colour correction edits.

18. The method of processing an image series of frames as claimed in claim 17, wherein in said step g) said plurality of duplication copies comprise digitized images of frames.

19. The method of processing an image series of frames as claimed in claim 18 wherein said component element is selected from said frame entirely and a field of said frame.

20. The method of processing an image series of frames as claimed in claim 19, wherein in said capture frame rate is 48 fps, said edit frame rate is 24 fps, said archive copy frame rate is 24 fps and said duplication frame rate is 24 fps.

21. The method of processing an image series of frames as claimed in claim 20, wherein said edit decision list for said edit copy reflects an edit point for every other frame of said image series for said presentation copy.
